(19) United States
(12) Patent Application Publication
(10) Pub. No.: US 2010/0079537 A1
(43) Pub. Date: Apr. 1, 2010

(54) HEAD CAP AND INK-JET PRINTER

(75) Inventor: Hidetoshi WATANABE, Tokoname-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/553,888

(22) Filed: Sep. 3, 2009

(30) Foreign Application Priority Data
Sep. 29, 2008 (JP) 2008-249890

(51) Int. Cl. B41J 2/165

(52) U.S. Cl. 347/31; 347/29

(57) ABSTRACT

A head cap, including: a bottom plate portion which has a bottom surface opposed to a liquid-droplets ejecting surface of a liquid-droplets ejecting head and through which a through hole is formed; a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area; a liquid holding member which covers at least a part of the bottom surface and which holds a liquid by a holding force determined on the basis of a frictional force with respect to the liquid and a capillary force, wherein the liquid holding member includes (a) a first area contacting with an opening portion of the through hole in the bottom surface and (b) a second area located further from the opening portion than the first area, and wherein the holding force of the first area is larger than that of the second area.

### CROSS REFERENCE TO RELATED APPLICATION

The present application claims priority from Japanese Patent Application No. 2008-249890, which was filed on Sep. 29, 2008, the disclosure of which is herein incorporated by reference in its entirety.

### BACKGROUND OF THE INVENTION

1. Field of the Invention

The present invention relates to a head cap which covers or caps an ink-ejection surface of a liquid-ejection head configured to eject liquid droplets, and relates to an ink-jet printer including the head cap.

2. Description of the Related Art

Patent Document 1 (U.S. Pat. No. 6,866,361B2 corresponding to JP-A-2004-142450) discloses an ink-jet recording apparatus including ink-jet heads and a maintenance unit which performs a maintenance of the ink-jet heads. In this ink-jet recording apparatus, the maintenance unit includes caps each formed of an elastic material such as rubber for covering or capping a nozzle surface (an ink-ejection surface) of the corresponding ink-jet head. Each cap defining a recessed portion is fitted so as to cover the nozzle surface, thereby preventing drying of an ink in nozzles. In this state, by performing a purging operation in which the ink is forced to be ejected from the nozzles, a thickened ink, foreign materials, and so on can be discharged to recover an ink-ejection performance of the nozzles.

### SUMMARY OF THE INVENTION

In accordance with downsizing of an ink-jet printer, downsizing of a cap is progressing. When the cap is downsized, a distance becomes short between an ink-ejection surface in a state in which the cap is fitted on the ink-ejection surface and a bottom surface of a recessed portion of the cap. Thus, when the above-described purging operation is performed, the ink ejected from the nozzles may be flown by being splattered against a bottom surface of the cap and adhere to the ink-ejection surface, and the ink accumulated on the bottom surface of the cap in a spherical shape may contact with the ink-ejection surface. Further, if the ink is accumulated in the recessed portion, the accumulated ink dries and, in turn, is likely to absorb moisture in the cap. Thus, in capping, the nozzles unfortunately dry.

This invention has been developed in view of the above-described situations, and it is an object of the present invention to provide a head cap which can efficiently discharge a liquid while preventing an unnecessary liquid from adhering to an ink-ejection surface.

The object indicated above may be achieved according to the present invention which provides A head cap, comprising: a bottom plate portion which has a bottom surface opposed to a liquid-droplets ejecting surface of a liquid-droplets ejecting head and through which a through hole is formed; a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area; a liquid holding member which covers at least a part of the bottom surface and which holds a liquid by a holding force determined on the basis of a frictional force with respect to the liquid and a capillary force, wherein the liquid holding member includes (a) a first area contacting with an opening portion of the through hole in the bottom surface and (b) a second area located further from the opening portion than the first area, and wherein the holding force of the first area is larger than that of the second area.

The object indicated above may also be achieved according to the present invention which provides an ink-jet printer, comprising: a liquid-droplets ejecting head including a liquid-droplets ejecting surface in which a liquid-droplets ejecting area is formed; and a head cap includes (a) a bottom plate portion which has a bottom surface opposed to the liquid-droplets ejecting surface of the liquid-droplets ejecting head and through which a through hole is formed, and (b) a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area, wherein the head cap further includes a liquid holding member which covers at least a part of the bottom surface and which holds a liquid by a holding force determined on the basis of a frictional force with respect to the liquid and a capillary force, wherein the liquid holding member includes (a) a first area contacting with an opening portion of the through hole in the bottom surface and (b) a second area located further from the opening portion than the first area, and wherein the holding force of the first area is larger than that of the second area.

According to the head cap and the ink-jet printer to each of which the present invention is applied, since the liquid ejected to the recessed portion is speedily absorbed and held in the liquid holding member, there can be prevented that the ejected liquid is accumulated in a spherical shape on the bottom surface of the recessed portion and that the liquid is splattered and flown. As a result, there can be restrained that an unnecessary liquid adheres to the liquid-droplets ejecting surface. Further, the liquid absorbed in the second area is moved to the first area having the larger holding force, whereby the liquid in the recessed portion is efficiently moved to the through hole. As a result, the liquid in the recessed portion can be efficiently discharged to an outside.

### BRIEF DESCRIPTION OF THE DRAWINGS

The objects, features, advantages, and technical and industrial significance of the present invention will be better understood by reading the following detailed description of a preferred embodiment of the invention, when considered in connection with the accompanying drawings, in which:

FIG. 1 is a side elevational view in cross section generally showing an ink-jet printer as an embodiment of the present invention;

FIG. 2 is a plan view generally showing a main portion of the ink-jet printer shown in FIG. 1;

FIG. 3 is a cross-sectional view taken along line III-III of FIG. 2;

FIG. 4 is a view of four ink-jet heads shown in FIG. 2 as seen from below;

FIG. 5A is a plan view of one of caps shown in FIG. 2, and FIG. 5B is a cross-sectional view of the cap;

FIG. 6 is a view showing a positional relationship between the cap and a corresponding ink-ejection surface;

FIG. 7 is a view showing a case in which a circular projection of the cap shown in FIG. 5 and the ink-ejection surface contact with each other;

FIG. 8A is a view showing a case in which one of the ink-jet heads shown in FIG. 2 is moved from a “print position” to a “head maintenance position” while a tray of a maintenance unit is moved to a “maintenance position”, and FIG. 8B is a view showing a case in which an ink adhering to the ink-ejection surface is being wiped by a wiper shown in FIG. 2; and

FIG. 9A is a plan view of one of caps according to a modification of the embodiment of the present invention, and FIG. 9B is a cross-sectional view of the cap.

### DESCRIPTION OF THE PREFERRED EMBODIMENTS

Hereinafter, there will be described a preferred embodiment of the present invention by reference to the drawings.

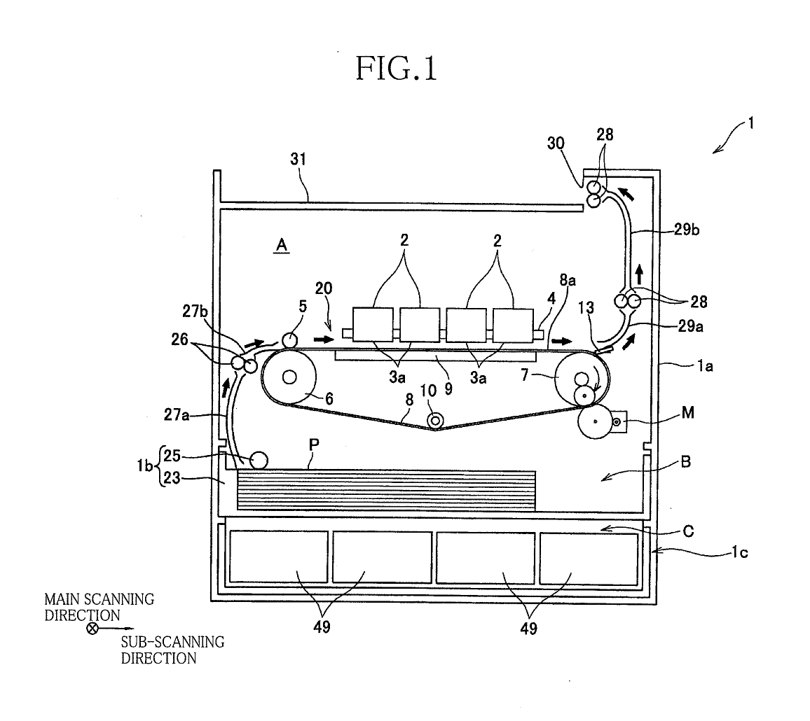

As shown in FIGS. 1-3, an ink-jet printer 1 includes a body 1a having a rectangular parallelepiped shape. A sheet-discharge portion 31 is provided at an upper portion of the body 1a. Further, an inside of the body 1a is separated into three spaces A, B, C in order from above. In the space A, there are disposed four ink-jet heads (i.e., liquid-droplets ejecting heads) 2 which respectively eject inks of four colors, namely, magenta, cyan, yellow, and black, a sheet-feed unit 20, and a maintenance unit 70 (on a back side of the sheet-feed unit 20 in FIG. 1). The spaces B, C are spaces in which a sheet-supply unit 1b and an ink tank unit 1c attachable and detachable to and from the body 1a are respectively disposed. It is noted that, in the present embodiment, a sub-scanning direction is a direction parallel to a sheet feeding direction in which each sheet P is fed by the sheet-feed unit 20 while a main scanning direction is a direction perpendicular to the sub-scanning direction and along a horizontal surface.

In the ink-jet printer 1, there is formed a sheet feeding path (indicated by boldface arrow in FIG. 1) in which each sheet P is fed from the sheet-supply unit 1b to the sheet-discharge portion 31. The sheet-supply unit 1b includes a sheet-supply tray 23 which can accommodate a plurality of the sheets P, and a sheet-supply roller 25 attached to the sheet-supply tray 23. The sheet-supply roller 25 supplies or feeds an uppermost one of the sheets P stacked on each other and accommodated in the sheet-supply tray 23. The sheet P supplied by the sheet-supply roller 25 is fed to the sheet-feed unit 20 while being guided by guides 27a, 27b and being nipped between a pair of feed rollers 26.

The sheet-feed unit 20 includes two belt rollers 6, 7, an endless sheet-feed belt 8 wound around the rollers 6, 7 so as to bridge the rollers 6, 7, and a tension roller 10. The tension roller 10 applies tension to the sheet-feed belt 8 by being biased downward while contacting with an inner peripheral surface of the sheet-feed belt 8 at a lower portion of the belt 8. A belt roller 7 is a drive roller rotated in a clockwise direction in FIG. 1 by being given a drive force from a sheet feeding motor M via two gears. The belt roller 6 is a driven roller rotated in the clockwise direction in FIG. 1 with rotation of the sheet-feed belt 8 by rotation of the belt roller 7.

An outer peripheral surface 8a of the sheet-feed belt 8 is subjected to a silicone treatment to have a viscosity. In the sheet feeding path, there is disposed a nipping roller 5 at a position opposite to the belt roller 6 in a state in which the sheet-feed belt 8 is interposed between the nipping roller 5 and the belt roller 6. The nipping roller 5 presses, toward the outer peripheral surface 8a of the sheet-feed belt 8, each sheet P supplied by the sheet-supply unit 1b. The sheet P pressed toward the outer peripheral surface 8a is fed rightward in FIG. 1 while being held by and on the outer peripheral surface 8a owing to the viscosity thereof.

A peeling plate 13 is provided in the sheet feeding path at a position opposite to the belt roller 7 in a state in which the sheet-feed belt 8 is interposed between the peeling plate 13 and the belt roller 7. The peeling plate 13 peels, from the outer peripheral surface 8a, each sheet P held by the outer peripheral surface 8a of the sheet-feed belt 8. The sheet P peeled by the peeling plate 13 is fed while being guided by guides 29a, 29b and being nipped between two pairs of feed rollers 28. Then, the sheet P is discharged to the sheet-discharge portion 31 from an opening 30 formed in an upper portion of the body 1a.

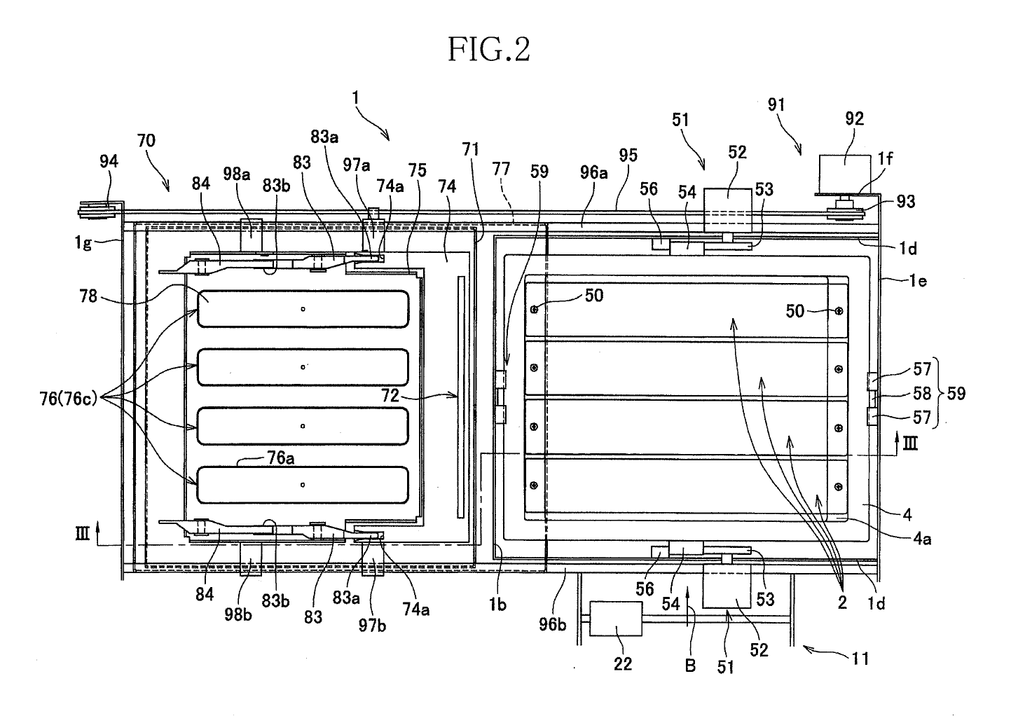

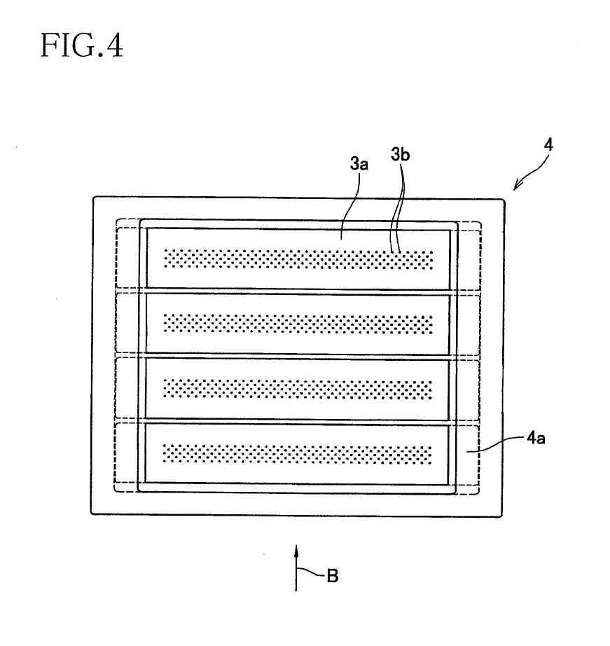

As shown in FIGS. 2-4, each of the four ink-jet heads 2 extends in the main scanning direction and is fixed to a frame 4 in a state in which the heads 2 are arranged adjacent to each other in a sheet feeding direction B. The frame 4 includes supporting portions 4a projected to positions respectively facing opposite end portions of a lower surface of the ink-jet head 2 in a longitudinal direction thereof. The supporting portions 4a and the respective opposite end portions of the ink-jet head 2 are fixed by screws 50. Further, as shown in FIG. 4, in an ink-ejection surface (i.e., a liquid-droplets ejecting surface) 3a of each ink-jet head 2, there are formed a plurality of nozzles 3b in the main scanning direction (i.e., the longitudinal direction of the ink-jet head 2). A direction in which the nozzles 3b are arranged in rows (i.e., a direction of rows of the nozzles) coincides with a longitudinal direction of caps 76 which will be described below. It is noted that an area of each ink-ejection surface 3a in which the nozzles 3b are formed functions as an ink-ejection area (i.e., a liquid-droplets ejecting area) of the ink-ejection surface 3a. Thus, the ink-jet printer 1 is a color ink-jet printer of a line type in which the ink-ejection area extending in the main scanning direction is formed.

As shown in FIG. 1, a platen 9 is disposed in a loop of the sheet-feed belt 8 so as to be opposed to the four ink-jet heads 2. An upper surface of the platen 9 contacts with the inner peripheral surface of the upper portion of the sheet-feed belt 8 and supports the sheet-feed belt 8 from a side of the inner peripheral surface thereof. As a result, the outer peripheral surface 8a of the upper portion of the sheet-feed belt 8 and the respective ink-ejection surfaces 3a of the ink-jet heads 2 are opposed and parallel to each other, and a constant space is formed between the ink-ejection surfaces 3a and the outer peripheral surface 8a of the sheet-feed belt 8. When each sheet P fed while being held by the outer peripheral surface 8a of the sheet-feed belt 8 is fed through just below the four ink-jet heads 2, the inks of the respective colors are sequentially ejected onto an upper surface of the sheet P from the ink-jet heads 2, thereby forming a desired color image on the sheet P.

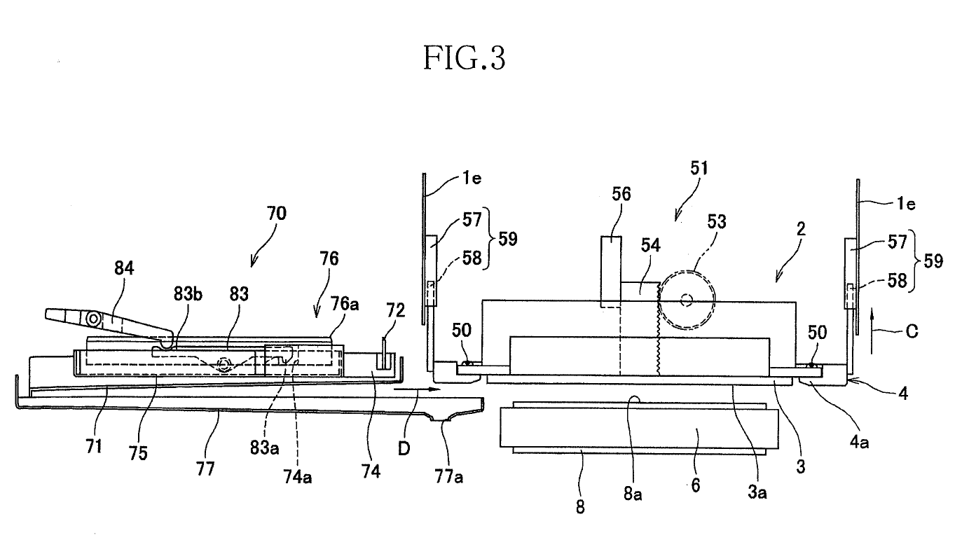

Further, as shown in FIGS. 2 and 3, the frame 4 is supported by frame moving mechanisms 51 provided in the ink-jet printer 1 so as to be movable upward and downward. The frame moving mechanisms 51 are disposed on outer sides of the four ink-jet heads 2 (i.e., an upper side and a lower side in FIG. 2). Each of the frame moving mechanisms 51 includes a drive motor 52, a pinion gear 53, a rack gear 54, and a guide 56. The drive motor 52 functions as a drive source which moves the frame 4 upward and downward. The pinion gear 53 is fixed to a shaft of the drive motor 52. The rack gear 54 is provided and stands on the frame 4 so as to be meshed with the pinion gear 53. The guide 56 is disposed at a position in which the guide 56 interposes the rack gear 54 with the pinion gear 53, that is, the guide 56 is disposed such that the rack gear 54 is interposed between the guide 56 and the pinion gear 53.

The two drive motors 52 are respectively fixed to main body frames 1d of the ink-jet printer 1 and disposed so as to be opposed to each other in the sheet feeding direction B. The two rack gears 54 extend in the vertical direction, and lower end portions thereof are respectively fixed to side faces of the frame 4. Further, a side face of each of the rack gears 54 which is opposite to a corresponding one of the pinion gears 53 slidably contacts with a corresponding one of the guides 56. The guides 56 are respectively fixed to the main body frames 1d.

In this configuration, when the two drive motors 52 are synchronized with each other, and the pinion gears 53 are forwardly or reversely rotated, the rack gear 54 are moved upward or downward. In accordance with the upward or downward movement of the rack gears 54, the frame 4 and the four ink-jet heads 2 are moved in the vertical direction.

Further, guide portions 59 are disposed on opposite sides of the ink-jet heads 2 in the longitudinal direction thereof. Each of the guide portions 59 is constituted by a rod member 58 and a pair of guides 57 slidably nipping the rod member 58 therebetween. As shown in FIG. 3, the pair of guides 57 extend in the vertical direction and are respectively fixed to main body frames 1e opposed to each other in a direction perpendicular to the sheet feeding direction B. On the other hand, the rod members 58 extend in the vertical direction like the guides 57 and respectively fixed to side faces of the frame 4 which are disposed parallel and opposite to respective side faces of the main body frames 1e. These guide portions 59 can prevent that the ink-ejection surfaces 3a of the respective ink-jet heads 2 are inclined relative to the outer peripheral surface 8a when the frame 4 is moved in the vertical direction.

The four ink-jet heads 2 are normally disposed at a “print position” (i.e., a position indicated in FIG. 3) at which the inks are ejected to the sheet to perform recording. In a maintenance operation of the ink-jet heads 2 (for example, in a purging operation in which the inks are forced to be ejected from the respective ink-jet heads 2, in a wiping operation for wiping the inks adhering to the ink-ejection surfaces 3a, and in a capping operation for covering or capping the ink-ejection surfaces 3a with the respective caps), the four ink-jet heads 2 are moved by the frame moving mechanisms 51, thereby being disposed at a “head maintenance position” located higher than the print position.

The ink-jet heads 2 are respectively connected to ink tanks 49 in the ink tank unit 1c installed in the space C. In the four ink tanks 49, the respective inks ejected from the ink-jet heads 2 are stored. The inks are respectively supplied to the ink-jet heads 2 from the ink tanks 49 via tubes or the like, not shown. The tubes are disposed along an inner face of the body 1a from the respective ink tanks 49. In a path to the ink-jet heads 2 located above, there are disposed sub-tanks which temporarily store the respective inks and pumps which respectively push up the inks to the sub-tanks.

There will be next explained in detail the maintenance unit 70 for performing the maintenance operation of the ink-jet heads 2. As shown in FIGS. 2 and 3, the maintenance unit 70 for performing the maintenance operation of the ink-jet heads 2 is disposed in the ink-jet printer 1 on a left side of the ink-jet heads 2 in FIG. 2. The maintenance unit 70 includes trays 71, 75 movable horizontally. The tray 71 has a generally square box-like shape having an opening opened upward and can enclose the tray 75. The tray 71 and the tray 75 are connected to each other by engaging means which will be described below so as to be attached and detached. The trays 71, 75 are attached and detached in accordance with a content of the maintenance operation.

The tray 71 is open at a side face thereof opposite to the ink-jet heads 2, and when the trays 71, 75 are disengaged in the wiping operation, for example, only the tray 71 is movable with the tray 75 remaining at its original position. Further, regardless of an engagement state of the engaging means, when the maintenance unit 70 is horizontally moved in a manner described below, the ink-jet heads 2 are moved upward to the head maintenance position located higher than the print position (i.e., in a direction indicated by arrow C in FIG. 3), so that a space for the maintenance unit 70 is assured between the four ink-ejection surfaces 3a and the outer peripheral surface 8a. Then, the maintenance unit 70 is horizontally moved in a direction indicated by arrow D in FIG. 3.

A waste-ink receiving tray 77 is disposed just below the maintenance unit 70. This waste-ink receiving tray 77 has a size enclosing the tray 71 in plan view. Even when the tray 71 is moved to an right end of the ink-jet printer 1 in FIG. 2, the waste-ink receiving tray 77 overlaps with one of opposite end portions of the tray 71, which one is located on a side opposite to the ink-jet heads 2. An ink-discharge hole 77a is vertically formed through one of opposite end portions of the waste-ink receiving tray 77 which one is nearer to the ink-jet heads 2. The ink-discharge hole 77a guides or discharges, to a waste-ink accumulating portion (not shown), the inks flown onto the waste-ink receiving tray 77.

A wiper 72 and the tray 75 are disposed in the tray 71 with the wiper 72 located nearer to the ink-jet heads 2 than the tray 75. The wiper 72 is formed of an elastic material and is for wiping the ink-ejection surfaces 3a in the wiping operation. The wiper is disposed so as to extend in a direction parallel to the sheet feeding direction B. As shown in FIG. 2, in the tray 75, the four caps 76 each having a rectangular shape in plan view are arranged side by side in correspondence with the respective ink-ejection surfaces 3a of the ink-jet heads 2. The longitudinal direction of the caps 76 is made parallel to a longitudinal direction of the ink-jet heads 2. The caps 76 are disposed in the sheet feeding direction B with pitches which are the same as pitches with which the ink-jet heads 2 are disposed in the sheet feeding direction B.

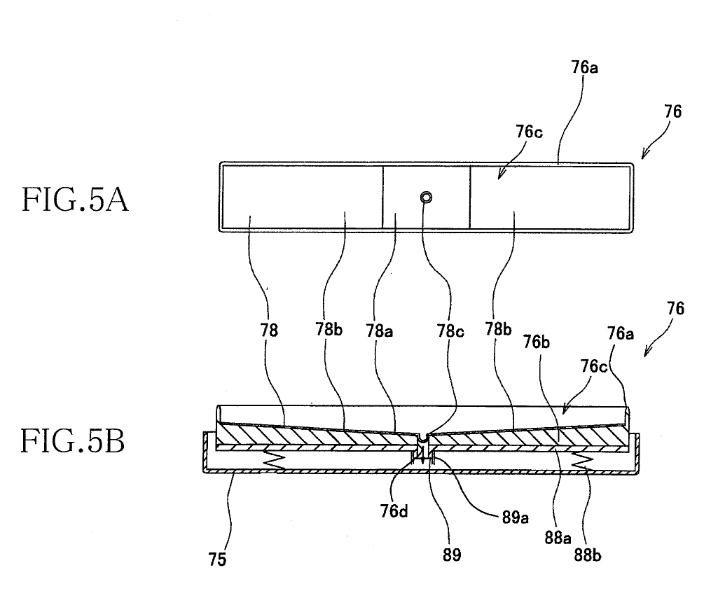

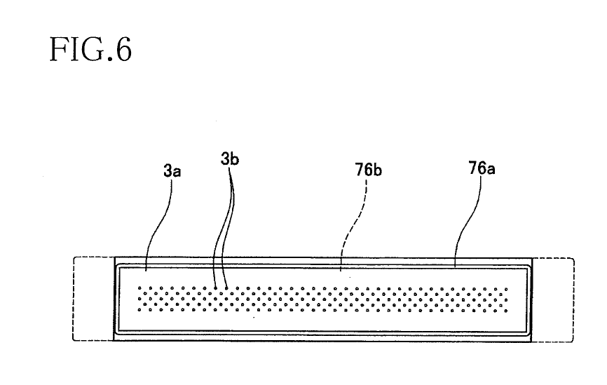

There will be explained the caps 76 with further reference to FIGS. 5A, 5B and 6. As shown in FIGS. 5A and 5B, each of the caps 76 includes a circular projection 76a having a generally rectangular shape projecting upward and a bottom plate portion 76b having an outer peripheral end portion to which a basal end portion of the circular projection 76a is connected and having a generally rectangular shape extending in one direction. The circular projection 76a and the bottom plate portion 76b are each formed of an elastic material such as a rubber and a resin, and integrally define a recessed portion 76c opening upward. The cap 76 is held by a holder 88a from below. As shown in FIG. 6, the circular projection 76a and a corresponding one of the ink-ejection surfaces 3a contact with each other by the capping operation which will be described below, and the circular projection 76a encloses the ink-ejection area by contacting at a distal end thereof with the ink-ejection surface 3a, whereby the recessed portion 76c in which the nozzles 3b are formed is sealed. Further, as shown in FIGS. 5A and 5B, at a center of a bottom surface of the bottom plate portion 76b, an ink-discharge hole 76d is formed through the bottom plate portion 76b from the bottom surface of the recessed portion 76c. The bottom surface of the recessed portion 76c has a rectangular shape and is inclined downward toward the ink-discharge hole 76d from opposite ends thereof in its longitudinal direction such that an opening of the ink-discharge hole 76d is located at a lowermost position of the bottom surface.

Further, each cap 76 includes an ink holding member (a liquid holding member) 78 which covers the bottom surface of the recessed portion 76c. The ink holding member 78 includes (a) a first area 78a having a rectangular shape and disposed at a center of the bottom surface of the recessed portion 76c in a longitudinal direction thereof so as to contact with the opening of the ink-discharge hole 76d in the bottom surface of the recessed portion 76c and (b) second areas 78b each having a rectangular shape and respectively adjacent to and contact with opposite ends of the first area 78a in the longitudinal direction along the bottom surface of the recessed portion 76c. That is, the second areas 78b are located further from the opening than the first area 78a. The first area 78a and the second areas 78b cover an entire width of the bottom surface of the recessed portion 76c in a widthwise direction thereof. At a center of the first area 78a, there is formed a projected portion 78c projected downward. The projected portion 78c is fitted into the ink-discharge hole 76d, whereby the ink holding member 78 is fixed to the bottom surface of the recessed portion 76c. As a result, the first area 78a reaches an inner wall surface of the ink-discharge hole 76d. It is noted that, in the present embodiment, a distal end portion of the projected portion 78c is hemisphere shape, and the projected portion 78c is fitted into the ink-discharge hole 76d, whereby the ink-discharge hole 76d is closed with the first area 78a. However, a hole may be formed in the distal end portion of the projected portion 78c in order that the ink is easily discharged to an outside. Further, the longitudinal direction of the bottom surface of the recessed portion 76c of the cap 76 coincides with the longitudinal direction of the ink-jet head 2, and the longitudinal directions coincide with the direction in which the nozzles 3b of the ink-ejection surface 3a are arranged in the rows. Consequently, the first area 78a and the second areas 78b are adjacent to each other in the direction of the nozzle rows.

Each of the first area 78a and the second areas 78b is a mesh member into which a stainless textile material is woven or knitted. In the mesh member (i.e., a woven fabric), there are formed a plurality of fine spaces for generating a capillary force (a width of each of the spaces formed by the mesh member falls within a range of 10 μm-200 μm), and thus the mesh member absorbs and holds the ink adhering to a front surface thereof by a holding force (an ink holding force) determined by a frictional force with respect to the ink and the capillary force. The ink holding force of the first area 78a is larger than that of the second areas 78b. Further, the ink holding member 78 is along the bottom surface of the recessed portion 76c and inclined downward toward the opening of the ink-discharge hole 76d. Thus, the ink held in the second areas 78b are easily moved to the first area 78a adjacent thereto. Further, as described above, since the first area 78a reaches the inner wall surface of the ink-discharge hole 76d, the ink moved to the first area 78a is moved into the ink-discharge hole 76d by gravity. It is noted that, in the present embodiment, for example, the width of each fine space of the first area 78a may be 10 μm while the width of each fine space of the second areas 78b may be 200 μm.

At a center of one of opposite surfaces of the holder 88a which is located on an opposite side of the cap 76, there is formed a joint portion 89 having a tubular shape and communicated with the ink-discharge hole 76d. To the joint portion 89 is connected a sucking pump 89a. By driving an sucking pump, not shown, to which the sucking pump 89a is connected, the ink absorbed and held by the ink holding member 78 are moved from the second areas 78b to the first area 78a, then pass through the projected portion 78c, and finally are discharged to an outside via the ink-discharge hole 76d and the sucking pump 89a. In this time, as described above, since the ink holding member 78 is inclined downward toward the ink-discharge hole 76d, the ink absorbed and held by the ink holding member 78 is efficiently guided to the ink-discharge hole 76d. In this time, a waste ink is discharged via the projected portion 78c of the ink holding member 78, and foreign materials are removed in correspondence with a size of the fine space of the projected portion 78c. That is, the projected portion 78c functions as a kind of filter, thereby enabling a reuse of the ink.

The holder 88a holding the bottom plate portion 76b is supported by the tray 75 via two springs (elastic materials) 88b and biased upward. Thus, the springs 88b reduce an impact force generated when the circular projection 76a and the ink-ejection surfaces 3a contact with each other. Further, even where a degree of parallelization of the circular projection 76a to the ink-ejection surface 3a has an error to a certain extent, it becomes possible that the circular projection 76a follows an inclination relative to the ink-ejection surface 3a.

As shown in FIGS. 2 and 3 again, a holding member 74 holding the wiper 72 is fixed to a portion of the tray 71 which is nearer to the ink-jet heads 2. The holding member 74 has a U-shape in its plan view, and the wiper 72 is held at a portion of the holding member 74 which extends in the sheet feeding direction B. On the other hand, recessed portions 74a partly constituting the engaging means are respectively formed on end parts of respective portions of the holding member 74 which portions extend in the direction perpendicular to the sheet feeding direction B.

As described above, the tray 71 and the tray 75 are engaged with each other by the engaging means so as to be attachable and detachable. The engaging means are respectively disposed near upper and lower ends of the trays 71, 75 in FIG. 2 and each mainly constituted by the recessed portion 74a formed in the holding member 74 and a hook member 83 supported by the tray 75. The hook member 83 extends in the direction perpendicular to the sheet feeding direction B, and is pivotably supported at a central portion thereof. A hook portion 83a which engages the recessed portion 74a is formed on one of opposite end portions of the hook member 83 nearer to the ink-jet heads 2. Above the maintenance unit 70, there is pivotably supported a contact member 84 that can contact with an end portion 83b of each hook member 83 which is located furthest from the ink-jet heads 2. When each contact member 84 is pivoted to contact with the end portion 83b, the hook portion 83a and the recessed portion 74a are disengaged from each other. On the other hand, when the contact member 84 is moved away from the end portion 83b, the hook portion 83a is engaged with the recessed portion 74a and returns to a state shown in FIG. 3.

When the maintenance operation of the ink-jet heads 2 which will be described below is not performed, the maintenance unit 70 is, as shown in FIG. 3, at rest at a “retracted position” distant from the ink-jet heads 2 (i.e., a left position in FIG. 2 at which the maintenance unit 70 does not face the ink-jet heads 2). When the maintenance operation is performed, the maintenance unit 70 is horizontally moved from the retracted position to a “maintenance position” at which the maintenance unit 70 faces the ejection surfaces 3a of the respective ink-jet heads 2. In this movement, distal ends of the wiper 72 and the circular projection 76a are not brought into contact with the ejection surfaces 3a because the ink-jet heads 2 are disposed at the head maintenance position.

It is noted that even when the maintenance operation is performed, only the tray 71 is moved, in the wiping operation, from the retracted position to a position under the ink-jet heads 2 to receive the inks wiped by the wiper 72, with the tray 75 remaining at its original position. When the ejection surfaces 3a are covered by the respective caps 76 in a stand-by state of the ink-jet printer 1 and in the purging operation, the tray 71 and the tray 75 are connected to each other by the engaging means and moved to the maintenance position.

As shown in FIG. 2, the trays 71, 75 are movably supported by a pair of guide shafts 96a, 96b extending in the direction perpendicular to the sheet feeding direction B. Two bearing members 97a, 97b are provided on the tray 71. The bearing members 97a, 97b are projected from respective upper and lower side faces of the holding member 74. Two bearing members 98a, 98b are provided on the tray 75. The bearing members 98a, 98b are projected from the respective upper and lower side faces of the tray 75. The pair of guide shafts 96a, 96b are respectively fixed, at opposite ends thereof, to the main body frame 1e and a main body frame 1g, and disposed so as to be parallel to each other between the main body frames 1e, 1g. Here, the pair of guide shafts 96a, 96b are fixed by screws. In this configuration, each of the trays 71, 75 is moved along the guide shafts 96a, 96b in a right and left direction in FIG. 2 (indicated by arrow D).

Here, there will be explained a horizontally moving mechanism 91 for horizontally moving the trays 71, 75. As shown in FIG. 2, the horizontally moving mechanism 91 includes a motor 92, a motor pulley 93, an idle pulley 94, a timing belt 95, the guide shafts 96a, 96b, and so on. The motor 92 is fixed by, e.g., screws to a mount portion 1f formed at one of end portions of the main body frame 1e extending in the direction parallel to the sheet feeding direction B. The motor pulley 93 is connected to the motor 92, and rotated in accordance with driving of the motor 92. The idle pulley 94 is rotatably supported by the main body frame 1g located at the most left side of the ink-jet printer 1 in FIG. 2. The timing belt 95 is disposed so as to be parallel to the guide shaft 96a and wound around the motor pulley 93 and the idle pulley 94 as a pair to bridge the motor pulley 93 and the idle pulley 94. The timing belt 95 is connected to the bearing member 97a provided on the holding member 74.

In this construction, when the motor 92 is driven, the timing belt 95 is rotated in accordance with a forward or a reverse rotation of the motor pulley 93. By the rotation of the timing belt 95, the tray 71 connected to the timing belt 95 via the bearing member 97a is moved leftward or rightward in FIG. 2, that is, in a direction toward the retracted position or the maintenance position. It is noted that in a state in which the recessed portion 74a of the holding member 74 and the hook portion 83a are engaged with each other, the wiper 72 in the tray 71 and the caps 76 in the tray 75 are moved together with each other. On the other hand, in a state in which the hook portion 83a and the recessed portions 74b are not engaged with each other, only the wiper 72 in the tray 71 is moved.

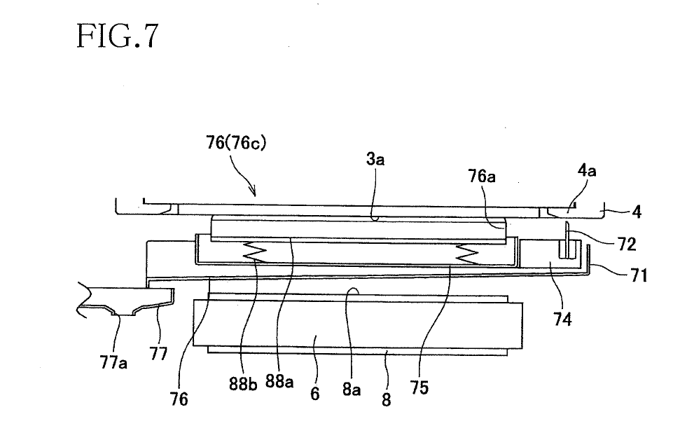

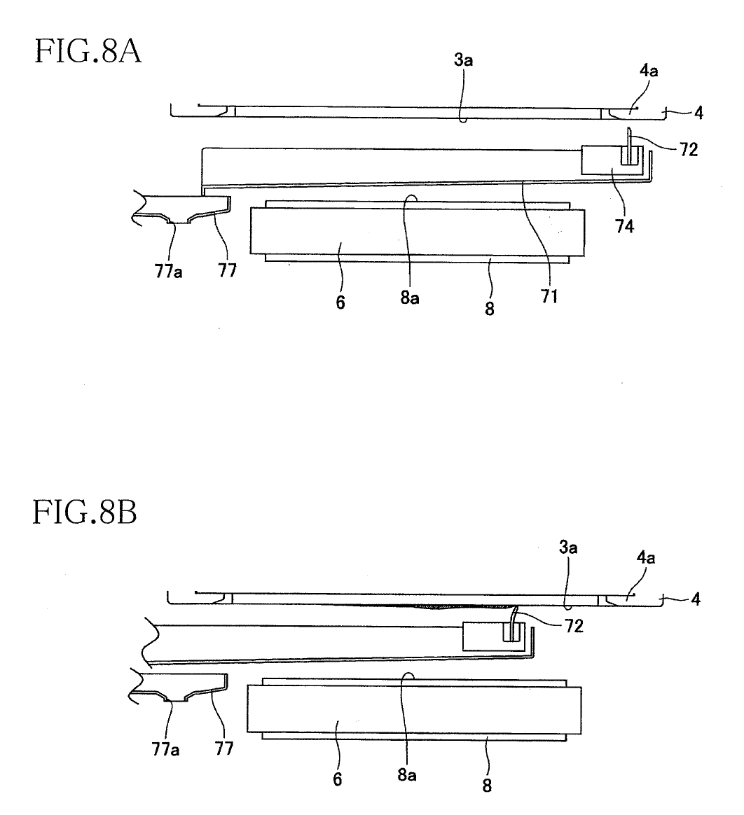

There will be next explained an operation of the maintenance unit 70 with reference to FIGS. 7, 8A, and 8B.

When performing the purging operation for recovering the ink-jet heads 2 in which ink ejection failure occurs, initially the capping operation in which the caps 76 respectively seal the ink-ejection surfaces 3a is performed. The frame 4 is moved upward by the frame moving mechanisms 51, whereby the ink-jet heads 2 are positioned at the head maintenance position. As a result, the space in which the maintenance unit 70 can be disposed is formed between the ink-ejection surfaces 3a and the sheet-feed belt 8.

Then, as shown in FIG. 7, the tray 71 and the tray 75 are moved from the retracted position to the maintenance position by the horizontally moving mechanism 91 in a state in which the tray 71 and the tray 75 are connected to each other by the hook member 83. In this time, the recessed portion 76c of each cap 76 is disposed at a position facing a surrounding of an area in which the corresponding nozzles 3b are formed. Further, the ink-jet heads 2 are moved toward a “capping position” from the head maintenance position by the frame moving mechanisms 51, whereby the circular projection 76a is brought into contact with the ink-ejection surface 3a. As thus described, the ink-ejection surface 3a is covered with the recessed portion 76c of the cap 76 to be sealed, and the capping operation is completed. This operation prevents drying of the nozzles 3b even where the stand-by state of the ink-jet printer 1 continues for a relatively long time.

Next, when performing the purging operation, in this state, the pump, not shown, forcing the ink in each ink tank 49 to feed to the corresponding ink-jet head 2 is driven, and the purging operation is performed in which the ink is ejected from the nozzles 3b of the ink-jet head 2 into the cap 76. This purging operation resolves clogging of the nozzles 3b of the ink-jet head 2 in which the ink ejection failure occurs, and thickening of the ink in the nozzles 3b.

In this time, concurrently with discharging the ink ejected into the cap 76 to the front surface of the ink holding member 78, the ink is absorbed and held in the ink holding member 78 owing to a balance between the frictional force (i.e., a water repellent force) and the capillary force. Further, as described above, since the ink holding force of the first area 78a is made larger than that of the second areas 78b, the ink absorbed and held in the second areas 78b is moved to the adjacent first area 78a. Further, since the ink holding member 78 is inclined downward toward the ink-discharge hole 76d along the bottom surface of the recessed portion 76c, the ink held in the ink holding member 78 is efficiently guided to the ink-discharge hole 76d. By driving the sucking pump, not shown, the ink guided to the ink-discharge hole 76d is discharged to the outside via the projected portion 78c and the ink-discharge hole 76d. A part of the ink, however, remains on the ink-ejection surface 3a as ink droplets.

It is noted that the ink holding force of the ink holding member 78 (i.e., the mesh member) is determined by the frictional force (i.e., the water repellent force) on the ink and the capillary force, and where the frictional force is relatively large, the ink is less likely to be absorbed in the ink holding member 78 when compared with a case in which the frictional force is relatively small. Thus, with respect to two ink holding members having the same capillary force on the ink, the ink holding force of the ink holding member having a relatively large frictional force is smaller than that of the ink holding member having a relatively small frictional force. Further, where the capillary force is relatively large, the ink is more likely to be absorbed in the ink holding member when compared with a case in which the capillary force is relatively small. Thus, with respect to two ink holding members having the same frictional force on the ink, the ink holding force of the ink holding member having a relatively large capillary force is larger than that of the ink holding member having a relatively small capillary force.

Next, in order to perform the wiping operation, the frame 4 is moved upward again by the frame moving mechanisms 51, thereby disposing the ink-jet heads 2 at the head maintenance position. Then, the tray 71 and the tray 75 are moved from the maintenance position to the retracted position by the horizontally moving mechanism 91. Then, the hook portion 83a is moved away from the recessed portion 74a by contacting the contact member 84 with the end portion 83b of the hook member 83, whereby the recessed portion 74a and the hook portion 83a are disengaged from each other. That is, the connection of the tray 71 and the tray 75 is released. In this state, as shown in FIG. 8A, the tray 71 is moved from the retracted position to the maintenance position by the horizontally moving mechanism 91.

Next, the ink-jet heads 2 are moved downward by the frame moving mechanisms 51. In this time, when the tray 71 is moved leftward in FIG. 7 (that is, in a direction from the maintenance position toward the retracted position), the ink-jet heads 2 are disposed at a position (i.e., a “wiping position”) at which the distal end of the wiper 72 can contact with the ink-ejection surfaces 3a. Then, as shown in FIG. 8B, the tray 71 is moved from the maintenance position to the retracted position by the horizontally moving mechanism 91.

In this wiping operation, since an upper end of the wiper 72 is located above the ink-ejection surfaces 3a, the wiper 72 contacts with the ink-ejection surfaces 3a while bending, thereby wiping the inks adhering to the ink-ejection surfaces 3a by the purging operation. The inks wiped by the wiper 72 are transferred on a surface of the wiper 72 and then flowed into the waste-ink receiving tray 77. Then, the inks are discharged from the ink-discharge hole 77a of the waste-ink receiving tray 77.

As thus described, the maintenance operation is completed in which the ink-jet heads 2 being subjected to the ink ejection failure are recovered by the capping operation and the purging operation, and the inks adhering to the respective ink-ejection surfaces 3a are wiped by the wiping operation.

According to the above-explained present embodiment, since the ink ejected into each cap 76 is speedily absorbed and held in the ink holding member 78 in the purging operation, there can be prevented that the ejected ink is accumulated in a spherical shape on the bottom surface of the recessed portion 76c and that the ink is splattered and flown. As a result, there can be restrained that an unnecessary ink adheres to the ink-ejection surface 3a. Further, a liquid absorbed in the second areas 78b is moved to the first area 78a having the larger holding force, whereby the ink in the cap 76 is efficiently moved to the ink-discharge hole 76d. As a result, the ink in the cap 76 can be efficiently discharged to the outside.

Further, in the ink holding member 78, since the first area 78a and the second areas 78b are adjacent to each other in the direction along the bottom surface of the recessed portion 76c, the ink ejected to a position distant from the ink-discharge hole 76d can be efficiently moved from the second areas 78b to the ink-discharge hole 76d via the first area 78a.

Further, at the center of the bottom plate portion 76b, the ink-discharge hole 76d is formed through the bottom plate portion 76b, and the bottom surface of the recessed portion 76c is inclined downward toward the ink-discharge hole 76d from the opposite ends of the bottom surface in its longitudinal direction such that the opening of the ink-discharge hole 76d is located at the lowermost position. Thus, the ink in the cap 76 is moved more efficiently to the ink-discharge hole 76d along the inclined bottom surface of the recessed portion 76c.

In addition, since the ink holding member 78 is fixed to the bottom surface of the recessed portion 76c by fitting of the projected portion 78c into the ink-discharge hole 76d, the ink holding member 78 can be easily fixed to the bottom plate portion 76b of the cap 76. This leads to a lower cost of the cap 76.

Further, the projected portion 78c functions as the filter which performs filtration of the waste ink, thereby enabling the reuse of the waste ink.

Further, since the ink holding member 78 is the mesh member into which the stainless textile material is woven or knitted, roughness or fineness of the fine space can be adjusted by adjusting roughness of the textile material to easily form the ink holding member 78 having a desired holding force. Further, the stainless textile material becomes stable with respect to the ink, leading to a long-life ink holding member 78.

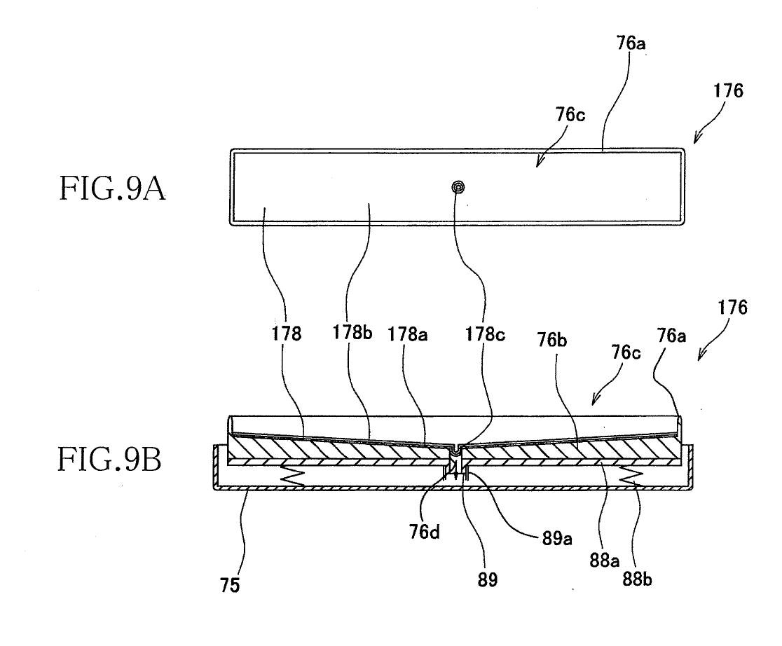

There will be explained a modification of the ink holding member with reference to FIGS. 9A and 9B. FIG. 9A is a plan view showing one of caps 176 according to the present modification as seen from a side of the ink-ejection surfaces 3a, and FIG. 9B is a cross-sectional view of the cap 176. As shown in FIGS. 9A and 9B, each of the caps 176 includes an ink holding member 178 which covers the bottom surface of the corresponding recessed portion 76c along the corresponding bottom plate portion 76b. Each ink holding member 178 includes (a) a first area 178a which covers an entirety of the bottom surface of the recessed portion 76c so as to contact with the opening of the ink-discharge hole 76d and (b) a second area 178b which covers the first area 178a (i.e., which is adjacent to the first area 178a in a direction perpendicular to the bottom surface of the recessed portion 76c). Further, a projected portion 178c projected downward is formed at a center of the first and second areas 178a, 178b. The projected portion 178c is fitted into the ink-discharge hole 76d, whereby the ink holding member 178 is fitted to the bottom surface of the recessed portion 76c.

According to this, in the above-described purging operation, an ink adhering to a front surface of the ink holding member 178, i.e., the second area 178b can be speedily moved to a portion of the first area 178a nearer to the bottom surface of the recessed portion 76c. Thus, the ink in the cap 176 is efficiently moved to the ink-discharge hole 76d.

It is to be understood that the present invention is not limited to the details of the illustrated embodiment, but may be embodied with various changes and modifications, which may occur to those skilled in the art, without departing from the spirit and scope of the present invention. For example, in the above-described embodiment, each of the first and second areas 78a, 78b has the rectangular shape, but may have any shape. For example, the first area may have a circular shape in which the first area contacts with or is adjacent to the opening of the ink-discharge hole 76d while the second area may have a shape in which the second area covers all areas of the bottom surface of the recessed portion 76c which are not covered with the first area.

Further, in the above-described embodiment, the ink holding member 78 has a configuration in which all areas of the bottom surface of the recessed portion 76c are covered with the first area 78a and the second areas 78b of the ink holding member 78, and, in the modification, the ink holding member 178 has a configuration in which all the areas of the bottom surface of the recessed portion 76c are covered with the first area 178a of the ink holding member 178, but each of the ink holding member 78 and the ink holding member 178 is not limited to this configuration. That is, only a part of the areas of the bottom surface of the recessed portion 76c may be covered with the ink holding member 78. For example, only an area of the bottom surface of the recessed portion 76c which is opposed to the nozzles 3b (i.e., the ink-ejection area) formed in the ink-ejection surface 3a of the corresponding ink-jet head 2 may be covered. Since there is a high possibility that the ink ejected from the nozzles 3b adheres to the area opposed to the nozzles 3b of the bottom surface of the recessed portion 76c, the ink can be reliably absorbed and held.

Further, in the above-described embodiment, each of the first and second areas has a uniform ink holding force, but the ink holding force may differ in each of the areas. In this case, the ink holding force preferably is set to become larger as being nearer to the ink-discharge hole 76d. This makes it possible that the ink absorbed and held in the ink holding member is moved more efficiently toward the ink-discharge hole 76d.

In addition, in the above-described embodiment, the ink holding member 78 is the mesh member into which the stainless textile material is woven or knitted, but the textile material may be formed of a material (including a nonmetal) other than a stainless material. Further, the ink holding member may be formed of another material having fine spaces generating the capillary force. For example, the ink holding member may be a nonwoven fabric formed by heating and pressurizing the textile material and may be a porous body that is a sintered material to which powder of metal, glass, or the like is sintered.

Further, in the above-described embodiment, the ink-discharge hole 76d is formed at the center of the bottom surface of the recessed portion 76c but may be formed at any position. Further, a plurality of the ink-discharge holes may be formed.

Further, in the above-described embodiment, the bottom surface of the recessed portion 76c is inclined downward toward the ink-discharge hole 76d, but may not be inclined.

In addition, in the above-described embodiment, the projected portion 78c of each ink holding member 78 is fitted into the ink-discharge hole 76d, whereby the ink holding member 78 is fixed to the bottom surface of the recessed portion 76c, but may be fixed by another method such as adhesive.

Further, in the above-described embodiment, the present invention is applied to the ink-jet printer 1, and a head cap unit constituted by the tray 75 and the four caps 76 is incorporated into the maintenance unit 70, but only the head cap unit may be independent. In this case, the head cap unit may have one, two, three, or more than or equal to five cap(s) 76.

What is claimed is:

1. A head cap, comprising:
a bottom plate portion which has a bottom surface opposed to a liquid-droplets ejecting surface of a liquid-droplets ejecting head and through which a through hole is formed;
a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area;
a liquid holding member which covers at least a part of the bottom surface and which holds a liquid by a holding force determined on the basis of a frictional force with respect to the liquid and a capillary force,
wherein the liquid holding member includes (a) a first area contacting with an opening portion of the through hole in the bottom surface and (b) a second area located further from the opening portion than the first area, and
wherein the holding force of the first area is larger than that of the second area.

2. The head cap according to claim 1,
wherein the liquid holding member covers at least a part of the bottom surface, which part is opposed to the liquid-droplets ejecting area.

3. The head cap according to claim 1,
wherein the first area and the second area are adjacent to each other.

4. The head cap according to claim 3,
wherein the first area and the second area are adjacent to each other in a direction along the bottom surface.

5. The head cap according to claim 4,
wherein the bottom surface has a rectangular shape as seen in a direction perpendicular to the bottom surface, and
wherein the first area and the second area are adjacent to each other in a longitudinal direction of the bottom surface.

6. The head cap according to claim 5,
wherein a plurality of second areas as the second area are respectively adjacent to opposite ends of the first area in the longitudinal direction.

7. The head cap according to claim 3,
wherein the first area and the second area are adjacent to each other in a direction perpendicular to the bottom surface.

8. The head cap according to claim 3,
wherein the first area and the second area are adjacent to each other in a direction along a row of nozzles formed in the liquid-droplets ejecting area.

9. The head cap according to claim 1,
wherein the opening portion is formed at a center of the bottom surface.

10. The head cap according to claim 1,
wherein at least a part of the bottom surface is inclined downward from an end portion of the bottom surface toward the opening portion.

11. The head cap according to claim 1,
wherein the first area includes a projected portion which is fitted into the through hole.

12. The head cap according to claim 1,
wherein a plurality of fine spaces generating a capillary force are formed in the liquid holding member.

13. The head cap according to claim 12,
wherein the liquid holding member is one of a woven fabric, a nonwoven fabric, and a porous body.

14. The head cap according to claim 1,
wherein the liquid holding member is formed of a stainless material.

15. The head cap according to claim 14,
wherein the liquid holding member is a mesh member into which a stainless textile material is woven.

16. An ink-jet printer, comprising:
a liquid-droplets ejecting head including a liquid-droplets ejecting surface in which a liquid-droplets ejecting area is formed; and
a head cap includes (a) a bottom plate portion which has a bottom surface opposed to the liquid-droplets ejecting surface of the liquid-droplets ejecting head and through which a through hole is formed, and (b) a projecting portion which functions as a side wall, which extends from the bottom plate portion so as to define a recessed portion with the bottom plate portion, and whose distal end contacts with a surrounding of a liquid-droplets ejecting area formed in the liquid-droplets ejecting surface so as to enclose the liquid-droplets ejecting area,
wherein the head cap further includes a liquid holding member which covers at least a part of the bottom surface and which holds a liquid by a holding force determined on the basis of a frictional force with respect to the liquid and a capillary force,
wherein the liquid holding member includes (a) a first area contacting with an opening portion of the through hole in the bottom surface and (b) a second area located further from the opening portion than the first area, and
wherein the holding force of the first area is larger than that of the second area.
